(19) United States
(12) Patent Application Publication
(10) Pub. No.: US 2011/0007678 A1
(43) Pub. Date: Jan. 13, 2011

(54) HIERARCHY FOR GROUP ADDRESSED FRAMES DELIVERY

(75) Inventors: Jarkko KNECKT, Espoo (FI); Mika KASSLIN, Espoo (FI); Janne MARIN, Espoo (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/498,954

(22) Filed: Jul. 7, 2009

(51) Int. Cl. G08C 17/00

(52) U.S. Cl. 370/311

(57) ABSTRACT

Method, apparatus, and computer program product embodiments are disclosed to improve power conservation and efficiency in wireless mesh networks. An example embodiment of the invention receives at a wireless mesh device a plurality of messages from other wireless mesh devices in a wireless mesh network and determines from the messages if there is one or more wireless peer mesh device in the network that is in a power save mode. If there is no wireless peer mesh device in the network that is in a power save mode, then the example embodiment transmits group addressed frames in any order. If there is at least one wireless peer mesh device in the network that is in a power save mode, then the example embodiment arranges a transmission order of group addressed frames that have a source different from a designated wireless mesh device in the network followed by group addressed frames that have the designated wireless mesh device as a source. Then the example embodiment transmits the group addressed frames in the transmission order to at least one other wireless mesh device in the network, with the group addressed frames having the designated wireless mesh device as a source being transmitted last. The arrangement of the order of transmission enables other wireless mesh devices operating in power save mode in the network to cease listening for further group addressed frames following receipt of the group addressed frames having the designated wireless mesh device as a source. In this manner power conservation and efficiency are improved in wireless mesh networks.

### FIELD

The embodiments relate to wireless communication, and more particularly to a network communication procedure for group addressed communication in wireless networks.

### BACKGROUND

Wireless communication devices continue to proliferate due, in part, to technological advances that have improved both Quality of Service (QoS) and functionality. As a result, these devices have become commonplace for both personal and business use, allowing users to transmit and receive voice, text, and graphical data from various locations. The wireless networks by which these exchanges may be executed span different frequencies and ranges.

For example, in IEEE 802.11s networks, a wireless distribution system (DS) to which an access point (AP) connects may be replaced by a mesh of interoperable wireless links or multi-hop paths. End stations may establish interoperable peer-to-peer wireless links with neighboring end stations and APs in an 802.11 wireless mesh network. Mesh Stations (mesh STAs) may support mesh services, i.e. they participate in interoperable formation and operation of a Mesh Basic Service Set (MBSS). A mesh basic service set (MBSS) is a basic service set (BSS) that forms a self-contained network of mesh stations (mesh STAs), and which may be used as a distribution system (DS). The configuration of a mesh STA that is collocated with an Access Point allows a single device to logically provide both mesh functionalities and AP functionalities simultaneously.

A mesh network consists of mesh stations (mesh STAs). All mesh STA devices have the same capability. Each mesh STA is capable of forward traffic. Each mesh STA transmits Beacons as per beacon interval determined by each mesh STA individually. Mesh STAs authenticate each other and provide a means to establish and manage links and peerings between mesh STAs. Peering is a logical relationship between two neighboring mesh STAs. A mesh network operates on the medium access control (MAC)-level and may operate as a bridge. Data type frame transmissions occur in links that a mesh STA establishes with neighbor mesh STAs. A link is a result of a peering in which two neighboring mesh STAs authenticate each other. Actual data delivery occurs across paths that are established on top of links. Paths are either single-hop or multi-hop paths depending on the number of links along the path. Any higher layer, e.g. the internet protocol (IP) layer for networking, considers a mesh as a single hop and does not need to be aware of mesh operations.

A logical peering: relationship is established from one mesh STA to another mesh STA with a mesh peering management protocol. Mesh STAs participate with other mesh STAs in mesh functionalities such as path selection and forwarding. Mesh STAs may propagate mesh frames over multiple hops and connectivity is provided to all member STAs.

Mesh portals interface the mesh network to other IEEE 802 LAN segments. A Portal Announcement (PANN) element is used to announce the presence of a mesh STA collocated with a portal in the mesh BSS. Portal Announcements allow mesh STAs to select the appropriate portal and build a path towards it. Portals may learn the addresses of the mesh STAs and of devices attached to these mesh STAs through the receipt of path selection messages. A mesh STA that receives a Portal Announcement message may propagate the Portal Announcement to neighboring STAs.

Data transmission occurs at the link layer using mesh paths that are formed out of links. Link and peering can be established only to a mesh STA from which Beacon frames can be received. The importance and role of Beacons is relevant to power save operations. Each mesh STA is responsible for participating in all the functionality essential for multi-hop data delivery in the mesh network. Data is forwarded across the paths between mesh STAs. At the link layer, data can be transmitted either in individually addressed frames or in group addressed data frames. When mesh STAs are in active mode, the addressing mode has very little, if any, influence on frame transmissions. The biggest general difference is that there is no ACK scheme for group addressed frames at the link layer. Use of power save complicates the situation and there are specific rules for both individually addressed and group addressed frame transmissions with power save.

Mesh STAs have a power mode that defines the used power management and power save level of a mesh STA as seen by neighboring mesh STAs. Mesh STAs have a power save level that indicates whether a mesh STA is in light sleep mode or deep sleep mode.

The IEEE 802.11s power save builds on two operation modes in a manner similar to BSS and IBSS. Active mode: Mesh STA is always on. Power save mode: Mesh STA saves power and uses power save features to be occasionally in doze state and off the channel. Power save comprises of two feature sets: Support for power save and Operation in power save.

The feature set of support for power save includes the capability to buffer frames and track the mesh power mode of each peer mesh STA. Individually addressed frames are transmitted to a peer mesh STA in power save mode when the peer mesh STA is in awake state. Awake state periods are called peer service periods and they are similar to the service periods in QoS-BSS networks. If the peer mesh STA is in active mode, a transmitting mesh STA can transmit individually addressed frames at any time as long as the normal channel access and transmission rules are obeyed. If any of a mesh STA's peer mesh STAs is in power save mode, group addressed frames are transmitted after a transmitting mesh STA's own Delivery Traffic Indication Message (DTIM) Beacon frame. If all the peer mesh STAs are in active mode, a transmitting mesh STA can transmit group addressed frames at any time. A Delivery Traffic Indication Message is a Traffic Indication Message (TIM), which informs the recipient of the presence of buffered data at the sender. It is generated within the periodic beacon at a frequency specified by the DTIM Interval. Normal Traffic Indication Messages (TIM) that are present in every beacon are for signaling the presence of buffered unicast data.

Every beacon has a TIM element that is used to indicate presence of buffered individually addressed frames to a peer device. The TIM element contains a bitmap in which one bit represents one device and if the bit is set to 1 that means that there is individually addressed frames buffered for that device. TIM elements are periodically DTIM elements, as per the DTIM Period value. In every TIM field there are DTIM Count and DTIM Period values that indicate how often the TIM element is a DTIM element and whether this TIM element is a DTIM element (DTIM Count=0) or whether it is just a normal TIM element (DTIM Count=non-zero value). In the DTIM element, one bit in the Bitmap Control field is used to indicate whether the device that transmitted the beacon has group addressed frames buffered. If there are, the device will transmit the buffered group addressed frames after the DTIM Beacon.

A transmitting mesh STA that has at least one peer mesh STA in power save transmits group addressed frames in any/random order after transmitting a DTIM Beacon. At the receiver, a power saving mesh STA listens to all the group addressed frames from its all peer mesh STAs.

IEEE 802.11s networks are described in the IEEE P802.11s™/D3.0 Draft Standard for Information Technology- Telecommunications and information exchange between systems—Local and metropolitan area networks—Specific requirements—Part II: Wireless LAN Medium Access Control (MAC) and Physical Layer (PHY) specifications Amendment 10: Mesh Networking, dated Mar. 2009, which is incorporated herein by reference.

### SUMMARY

Method, apparatus, and computer program product embodiments are disclosed to improve power conservation and efficiency in wireless mesh networks. An example embodiment of the invention receives at a wireless mesh device a plurality of messages from other wireless mesh devices in a wireless mesh network and determines from the messages if there is one or more wireless peer mesh device in the network that is in a power save mode. If there is no wireless peer mesh device in the network that is in a power save mode, then the example embodiment transmits group addressed frames in any order. If there is at least one wireless peer mesh device in the network that is in a power save mode, then the example embodiment arranges a transmission order of group addressed frames that have a source different from a designated wireless mesh device in the network followed by group addressed frames that have the designated wireless mesh device as a source. Then the example embodiment transmits the group addressed frames in the transmission order to at least one other wireless peer mesh device in the network, with the group addressed frames having the designated wireless mesh device as a source being transmitted last. The arrangement of the order of transmission enables other wireless mesh devices in the network to cease listening for further group addressed frames following receipt of the group addressed frames having the designated wireless mesh device as a source. In this manner power conservation and efficiency are improved in wireless mesh networks.

In an example embodiment of the invention, the designated wireless mesh device is a portal wireless mesh device in the network.

In an example embodiment of the invention, the messages are beacons transmitted from other wireless mesh devices in the wireless mesh network.

In an example embodiment of the invention, the transmitting occurs after transmitting a Delivery Traffic Indication Message Beacon.

In an example embodiment of the invention, the group addressed frames are group addressed (multicast/broadcast) frame communication in an IEEE 802.11s wireless mesh network.

Another example embodiment of the invention may be an apparatus including a transceiver configured to receive a plurality of wireless messages from other wireless mesh devices in a wireless mesh network. The example embodiment of the invention includes a processor configured to determine from the messages if there is one or more wireless peer mesh device in the network that is in a power save mode. The processor is further configured to determine if there is no wireless peer mesh device in the network that is in a power save mode, then to cause the transceiver to transmit group addressed frames in any order. The processor is further configured to determine if there is at least one wireless mesh device in the network that is in a power save mode, then to arrange a transmission order of group addressed frames that have a source different from a designated wireless mesh device in the network followed by group addressed frames that have the designated wireless mesh device as a source. The transceiver is further configured to transmit the group addressed frames in the transmission order to at least one other wireless peer mesh device in the network, with the group addressed frames having the designated wireless mesh device as a source being transmitted last. The arrangement of the order of transmission enables other wireless mesh devices in the network to cease listening for further group addressed frames following receipt of the group addressed frames having the designated wireless mesh device as a source. In this manner power conservation and efficiency are improved in wireless mesh networks.

Another example embodiment of the invention may be a computer readable medium configured to store program instructions, which when executed by a computer processor, perform the steps comprising:

receiving at a wireless mesh device a plurality of messages from other wireless mesh devices in a wireless mesh network;

determining from the messages if there is one or more wireless peer mesh device in the network that is in a power save mode;

if there is no wireless peer mesh device in the network that is in a power save mode, then transmitting group addressed frames in any order;

if there is at least one wireless peer mesh device in the network that is in a power save mode, then arranging a transmission order of group addressed frames that have a source different from a designated wireless mesh device in the network followed by group addressed frames that have the designated wireless mesh device as a source; and

transmitting the group addressed frames in the transmission order to at least one other wireless mesh device in the network, with the group addressed frames having the designated wireless mesh device as a source being transmitted last.

An example embodiment of the invention receives at a wireless mesh device operating in power save mode in a wireless mesh network, message frames sent by a selected wireless peer mesh device in the network and message frames sent by other wireless mesh devices in the network. Then the example embodiment listens to all group addressed frames of the message frames sent from the selected wireless peer mesh device. Then the example embodiment listens only to group addressed frames of the message frames from the other wireless peer mesh devices, which originated from a source different from a designated wireless mesh device in the network.

In an example embodiment of the invention, the designated wireless mesh device is a portal wireless mesh device in the network.

In an example embodiment of the invention, the ceasing to listen for further group addressed frames follows receipt of the group addressed frames having the designated wireless mesh device as a source.

In an example embodiment of the invention, selecting a wireless mesh device in the network from which to receive the message frames.

Another example embodiment of the invention may be an apparatus including a transceiver configured to receive at a wireless mesh device operating in power save mode in a wireless mesh network, message frames sent by a selected wireless peer mesh device in the network and message frames sent by other wireless peer mesh devices in the network. The example embodiment of the invention includes a processor configured to listen to all group addressed frames of the message frames sent from the selected wireless peer mesh device. The example embodiment of the invention includes the processor further configured to listen only to group addressed frames of the message frames from the other wireless peer mesh devices, which originated from a source different from a designated wireless mesh device in the network.

Another example embodiment of the invention may be a computer readable medium configured to store program instructions, which when executed by a computer processor, perform the steps comprising:

receiving at a wireless mesh device operating in power save mode in a wireless mesh network, message frames sent by a selected wireless peer mesh device in the network and message frames sent by other wireless peer mesh devices in the network;

listening to all group addressed frames of the message frames sent from the selected wireless peer mesh device; and

listening only to group addressed frames of the message frames from the other wireless peer mesh devices, which originated from a source different from a designated wireless mesh device in the network.

In an example embodiment of the invention, the group addressed frames are group addressed (multicast/broadcast) frame communication in a IEEE 802.11s wireless mesh network.

When a transmitting mesh STA has peer mesh STAs and at least one of them is in power save mode, the mesh STA orders the group addressed frames so that the frames that have the source address different from the portal address are transmitted first. Once those frames have been transmitted, the transmitting mesh STA continues with the group addressed frames that have the portal as the source.

A receiving mesh STA selects one peer mesh STA from which it receives all of the group addressed frames. The receiving mesh STA operating in power save mode listens to all of the group addressed frames from that peer mesh STA until the receiving mesh STA receives a frame with the More Data field set to zero. The receiving mesh STA receives from the other peer mesh STAs only the group addressed frames that have a source address different from the portal address (i.e., the group addressed frames that were transmitted first). The receiving mesh STA listens to the group addressed frames until the receiving mesh STA receives either a group addressed frame with the More Data field set to zero or a group addressed frame that has the portal as the source.

In this manner power conservation and efficiency are improved in wireless mesh networks.

### DESCRIPTION OF THE FIGURES

FIG. 1 illustrates an example embodiment of a wireless mesh device STA-MP3.

FIG. 2 illustrates an example embodiment of an IEEE 802.11s wireless mesh network.

FIG. 3 illustrates an example embodiment of the IEEE 802.11s wireless mesh network of FIG. 2, wherein a reordered arrangement for group addressed frames is transmitted in response to the determination that one of the wireless mesh devices in the network is in the power save mode.

FIG. 4 is an example timing diagram comparing the beacon timing for an active wireless mesh device, a wireless mesh device in the light sleep power save mode and a wireless mesh device in the deep sleep power save mode in the bottom row.

FIG. 5 is an example timing diagram showing the initial order of the group addressed frames as they are received at a first wireless mesh device and the reordering the received group addressed frames, which is triggered by determining there is at least one wireless mesh device in the network that is in a power save mode.

FIG. 6 illustrates an example embodiment of a flow diagram 600 for the process in an example wireless mesh device.

FIG. 7 illustrates an example embodiment of a flow diagram 700 for the process in a wireless mesh device in a wireless mesh network.

### DISCUSSION OF EXAMPLE EMBODIMENTS

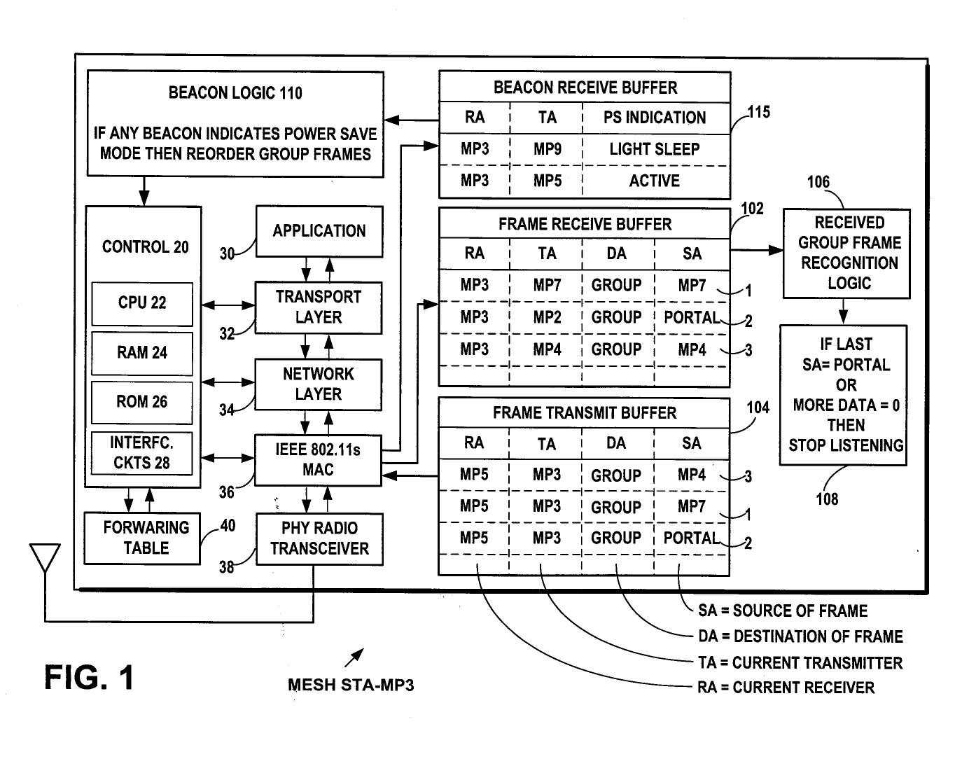

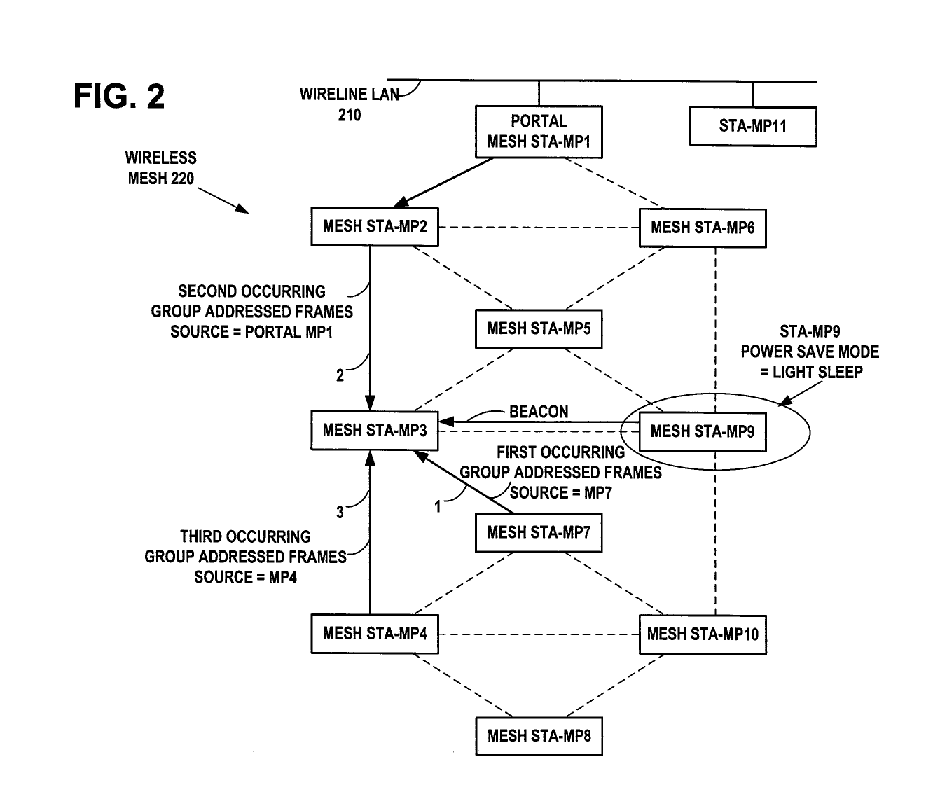

FIG. 1 illustrates an example embodiment of a wireless mesh device STA-MP3 in an example embodiment of an IEEE 802.11s wireless mesh network 220 shown in FIG. 2. The several wireless mesh devices shown in the network of FIG. 2 may each have substantially the same organization and components shown for the wireless mesh device STA-MP3 of FIG. 1. Generally, wireless mesh device STA-MP3 includes an IEEE 802.11s wireless mesh network MAC 36 and a transceiver 38 configured to receive a plurality of wireless beacon messages in the beacon receive buffer 115 from other wireless mesh devices in the wireless mesh network 220. The beacon receive buffer 115 includes fields RA for the address of the current receiver, TA for the address of the current transmitter, and PS Indication for the power save mode state of the transmitting device, which can be either active mode, light sleep mode, or deep sleep mode. The beacon receive buffer 115 is shown having received a beacon from wireless mesh device STA-MP9 with a power save (PS) indication that it is in the light sleep mode. The beacon logic 110 detects if there is any received beacon that indicates a power save mode in the light sleep mode and if so, then it sends a signal to the processor controller 20 to reorder the group addressed frames for transmission.

IEEE 802.11s wireless mesh network MAC 36 and a transceiver 38 are configured to receive individually addressed and group addressed frames in the frame receive buffer 102 from other wireless mesh devices in the wireless mesh network 220. The frame receive buffer 102 includes fields RA for the address of the current receiver, TA for the address of the current transmitter, DA for the destination of the frame, and SA for the source of the frame. The frame receive buffer 102 is shown having received three group addressed frames. The first Group addressed frames 1 are the first occurring group addressed frames received by mesh STA-MP3 from mesh STA-MP7, having the destination of the frames DA=Group and having the source of the frames SA=MP7. The second Group addressed frames 2 are the second occurring group addressed frames received by mesh STA-MP3 from mesh STA-MP2, having the destination of the frames DA=Group and having the source of the frames SA=the portal device MP1. The third Group addressed frames 3 are the third occurring group addressed frames received by mesh STA-MP3 from mesh STA-MP4, having the destination of the frames DA=Group and having the source of the frames SA=MP4.

IEEE 802.11s wireless mesh network MAC 36 and a transceiver 38 are configured to transmit individually addressed and group addressed frames in the frame transmit buffer 104 to other wireless mesh devices in the wireless mesh network 220. The frame transmit buffer 104 includes fields RA for the address of the current receiver, TA for the address of the current transmitter, DA for the destination of the frame, and SA for the source of the frame. The frame transmit buffer 104 is shown with a reordered arrangement for the three group addressed frames 1, 2, and 3 in response to the determination that one of the wireless mesh devices in the network 220 is in the power save mode. The frame transmit buffer 104 is shown with a reordered arrangement so that the group addressed frames 3 and 1 having a source different from the portal wireless mesh device STA1 are transmitted first followed by group addressed frames 2 that have the portal wireless mesh device STA1 as a source.

The wireless mesh device STA-MP3 includes processor control 20 configured to determine from the messages if there is one or more wireless peer mesh device in the network 220 that is in a power save mode. The processor 20 is further configured to determine if there is no wireless peer mesh device in the network 220 that is in a power save mode, then to cause the transceiver 38 to transmit group addressed frames in any order. The group addressed frames are group addressed (multicast/broadcast) frame communications in the IEEE 802.11s wireless mesh network 220. The processor 20 is further configured to determine if there is at least one wireless peer mesh device in the network 220 that is in a power save mode, then to arrange a transmission order of group addressed frames that have a source different from a designated wireless mesh device, such as the portal mesh device STA-MP1 in the network 220 followed by group addressed frames that have the designated portal mesh device STA-MP1 as a source. The transceiver 38 is further configured to transmit the group addressed frames in the transmission order to at least one other wireless mesh device STA-MP5 in the network 220, with the group addressed frames having the designated portal mesh device STA-MP1 as a source being transmitted last. The transmitting may occur after transmitting a Delivery Traffic Indication Message Beacon. The arrangement of the order of transmission enables the wireless peer mesh devices in the network 220 to cease listening for further group addressed frames following receipt of the group addressed frames having the designated portal mesh device STA-MP1 as a source. In this manner power conservation and efficiency are improved in wireless mesh networks.

The neighboring wireless mesh device STA-MP5 in FIG. 2 has substantially the same organization and components shown for the wireless mesh device STA-MP3 of FIG. 1. The neighboring wireless mesh device STA-MP5 includes an IEEE 802.11s wireless mesh network MAC 36 and a transceiver 38 operating in power save mode configured to receive message frames sent by a selected wireless mesh device, such as STA-MP3, in the network 220 and message frames sent by other wireless mesh devices in the network. The example embodiment of the invention includes a processor 20 configured to cause the wireless mesh device to listen to all group addressed frames of the message frames sent from the selected wireless mesh device STA-MP3. The processor 20 is further configured to cause the wireless mesh device to listen only to group addressed frames of the message frames from the other wireless mesh devices, which originated from a source different from the designated portal mesh device STA-MP1 in the network. The wireless mesh device of FIG. 1 includes a received group frame logic 106 connected to the frame receive buffer, to detect if the last received group addressed frames had the source address SA equal to the portal address STA1 or if the “more data” field of the frame was equal to zero. If so, then the receiving wireless mesh device stops listening for additional group addressed frames.

When the wireless mesh device STA-MP3 has peer mesh STAs in network 220 and at least one of them is in power save mode, the mesh STA-MP3 orders the group addressed frames so that the frames that have the source address different from the portal address of the designated portal mesh device STA-MP1 are transmitted first. Once those frames have been transmitted, the transmitting mesh STA-MP3 continues with the group addressed frames that have the designated portal mesh device STA-MP1 as the source.

The receiving wireless mesh device STA-MP5 selects one peer, for example the wireless mesh device STA-MP3, from which it receives all of the group addressed frames. The receiving wireless mesh device STA-MP5 operating in power save mode listens to all of the group addressed frames from that peer mesh STA-MP3 until the receiving mesh STA-MP5 receives a frame with the More Data field set to zero. The receiving mesh STA-MP5 receives from the other peer mesh STAs only the group addressed frames that have a source address different from the designated portal mesh device STA-MP1 address (i.e., the group addressed frames that were transmitted first). The receiving mesh STA-MP5 listens to the group addressed frames until the receiving mesh STA-MP5 receives either a group addressed frame with the More Data field set to zero or a group addressed frame that has the designated portal mesh device STA-MP1 as the source. The arrangement of the order of transmission enables the receiving mesh STA-MP5 in the network 220 to cease listening for further group addressed frames following receipt of the group addressed frames having the designated portal mesh device STA-MP1 as a source. In this manner power conservation and efficiency are improved in wireless mesh networks.

The several wireless mesh devices shown in the network of FIG. 2 may be mobile communications devices, PDAs, cell phones, laptops or palmtop computers, or the like. The wireless devices may also be integrated components of a vehicle, such as an automobile, bicycle, airplane or other mobile conveyance. The several wireless mesh devices shown in the network of FIG. 2 are typically mobile and are powered by a battery included in the device, whose power needs to be conserved by the device operating in power save mode.

The wireless mesh device STA-MP3 includes a control module 20, which includes a central processing unit (CPU) 22, a random access memory (RAM) 24, a read only memory (ROM) or programmable read only memory (PROM) 26, and interface circuits 28 to interface with forwarding table 40, a key pad, display, optional microphone, speakers, ear pieces, and camera or other imaging devices, etc. The RAM 24 and PROM 26 may be removable memory devices such as smart cards, Subscriber Identity Modules (SIMs), Wireless Application Protocol Identity Modules (WIMs), semiconductor memories such as a RAM, ROM, or PROM, flash memory devices, etc. The Medium Access Control (MAC) Layer 36 of the network protocol of the wireless device and/or application program 30 may be embodied as program logic stored in the RAM 24 and/or PROM 26 in the form of sequences of programmed instructions which may be executed in the CPU 22, carry out the functions of the disclosed embodiments. The program logic may be delivered to the writeable RAM, PROM, flash memory device, etc. 24 of the wireless mesh device STA-MP3 from a computer program product or article of manufacture in the form of computer-usable media such as resident memory devices, smart cards or other removable memory devices, or in the form of program logic transmitted over any transmitting medium which transmits such a program. Alternately, the MAC Layer 36 and/or application program 30 may be embodied as integrated circuit logic in the form of programmed logic arrays or custom designed application specific integrated circuits (ASIC). The transceiver 38 in wireless mesh device STA-MP3 operates in accordance with the network protocol of the wireless device. The MAC layer 36 may operate using, for example the IEEE 802.11s standard, for example as specified above.

IEEE 802.11s defines a communication protocol for WLAN based mesh networking where there is no single control point for the network. A specific portal node is responsible for initiating various control messaging within the network and serves as an access node to the external network. The basis for 802.11s networking is that nodes communicate with other peer nodes in the network over direct wireless links that are not controlled by any other nodes. Further, all nodes transmit beacons on beacon interval and nodes indicate in the beacons their presence in the network. The portal node also initiates specific Portal Announcement (PANN) frames to create unidirectional paths from within the network (to the portal node) and distribute availability information within the network.

Group addressed frames in the IEEE 802.11s standard utilize flooding for distributing the group addressed frames. This may create unnecessary transmissions of the group addressed frames within the network, which may impose unnecessary overhead and increased awake times for the network nodes, since the devices need to listen to the repetitive group addressed frames.

Embodiments of the invention enhance power saving for group addressed (multicast/broadcast) frame communication by defining a transmission order for the group addressed frames. The procedure for reordering the received group addressed frames is triggered by the processor 20 determining if there is at least one wireless peer mesh device in the network 220 that is in a power save mode, then to arrange a transmission order of group addressed frames that have a source different from a designated wireless mesh device, such as the portal mesh device STA-MP1 in the network 220, followed by group addressed frames that have the designated portal mesh device STA-MP1 as a source.

Each node in the wireless mesh network selects and monitors one other node from which it listens to all group addressed frames. The monitoring device, if it operates in power save, may stop listening for group addressed frames after receiving the first group addressed frame having the portal node identified as a source node (i.e., group addressed frames that have been initiated by the portal node). In example embodiments of the invention, the selection of the peer node from which to monitor and listen for all group addressed frames may be based on the Portal Announcement (PANN) frames that indicate to each node in the network the “best/optimal” route to the portal node. The Portal Announcement (PANN) frames are used to create unidirectional paths (from PANN receivers to the portal) and distribute the availability information from the portal.

Frames that originate at a mesh STA and are intended for another mesh STA in the MBSS may be transmitted using a four-address format, where the four address fields are set as follows:
Address 1: The address of the next-hop mesh STA (toward the Destination mesh STA)
Address 2: The address of the Transmitter mesh STA
Address 3: The address of the Destination mesh STA
Address 4: The address of the Source mesh STA

Frames that do not originate or are not intended for another mesh STA in the MBSS may be transmitted using the six-address format, wherein:
Address 5: The address of the destination end point (may be the same as Address 3 if the destination is the mesh STA at the end of the mesh path)
Address 6: The address of the source end point (may be the same as Address 4 if the source is the mesh STA at the beginning of the mesh path)

On receipt of an individually addressed mesh frame, a mesh STA may check to see whether the Address 3 field is known. If it is an unknown address, the mesh STA may trigger a path discovery procedure.

A mesh STA that is the source of a group addressed frame may use a three-address group addressed frame, wherein Address 3 may be set to the group address, and Address 2 may be set to the mesh STA's own MAC address. On receipt of a frame with a group address, a mesh STA may set Address 2 to its own MAC address and the frame is queued for transmission to neighboring STAs.

In the feature set of operation in power save, a mesh STA indicates that it is in power save mode and it may transition between active and doze states. Such a mesh STA is called a power saving mesh STA. Each mesh STA transmits Beacon frames that are specific to MBSS. Beacon generation and transmission rules are very similar to the ones of an access point (AP).

There are two kinds of Traffic Indication Messages (TIM): TIM and Delivery Traffic Indication Message (DTIM). At each target beacon transmission time (TBTT), the mesh STA schedules a Beacon frame as the next frame for transmission. A TIM element will be in every Beacon and it will be used to indicate presence of buffered traffic for peer mesh STAs in power save mode. In every Nth Beacon (the DTIM period) the TIM will be a DTIM. Upon transmitting a Beacon frame with DTIM, a mesh STA sends buffered group addressed frames before transmitting any individually addressed frames.

A power saving mesh STA is either in light sleep or in deep sleep mode. In light sleep mode the mesh STA listens to all the Beacon frames from its peer mesh STAs. From the Beacons it checks whether there is buffered individually addressed frames to itself. If there is, the mesh STA should try to initiate a peer service period to retrieve the frames from the peer mesh STA. If the received Beacon frame is a DTIM Beacon, the Beacon contains an indicator whether the beaconing mesh STA has group addressed frames buffered. If it does, the mesh STA keeps awake to receive buffered group addressed frames from the peer mesh STA that transmitted the DTIM Beacon. The end of the group addressed frame sequence is indicated with the More Data field. It is set to zero by the transmitting mesh STA in the last group addressed frame of the sequence.

In deep sleep mode the mesh STA may choose not to listen to the Beacons from its peer mesh STAs. It can be reached during a Mesh Awake Window following at least every DTIM Beacon.

The Hybrid Wireless Mesh Protocol (HWMP) is a mesh path selection protocol that combines the flexibility of on-demand path selection with proactive topology tree extensions. HWMP supports two modes of operation depending on the configuration. These modes provide different levels of functionality, the on demand mode and the proactive tree building mode. In the on demand mode, the functionality of this mode is always available. It allows mesh STAs to communicate using peer-to-peer paths. The mode is used in situations where there is no root mesh STA configured. It is also used if there is a root mesh STA configured and an on demand path may provide a better path to a given destination in the mesh. The proactive tree building mode is an additional functionality that may be added to the on demand mode.

FIG. 2 illustrates an example embodiment of an IEEE 802.11s wireless mesh network 220. The several example wireless mesh devices STA-MP2 through STA-MP10 shown in the example network of FIG. 2, are typically mobile and are powered by a battery included in the device, whose power needs to be conserved by the device operating in power save mode. Wireless mesh device STA-MP1 is a portal device connected to the wireline LAN 210 and a wireline-connected device STA-MP11. Since wireless mesh device STA-MP1 is a portal device connected to the wireline LAN 210, it may be stationary in some example embodiments, and draw its power from the mains, instead of from a battery. Wireless mesh device STA-MP7 transmits a first occurring group addressed frame 1 with a source SA=MP7, to the Wireless mesh device STA-MP3. Wireless mesh device STA-MP2 transmits a second occurring group addressed frame 2 with a source SA=the portal device MP1, to the Wireless mesh device STA-MP3. Wireless mesh device STA-MP4 transmits a third occurring group addressed frame 3 with a source SA=MP4 to the Wireless mesh device STA-MP3. Wireless mesh device STA-MP9 is in the power save mode=light sleep and sends a beacon to Wireless mesh device STA-MP3 indicating its power save mode state of “light sleep”.

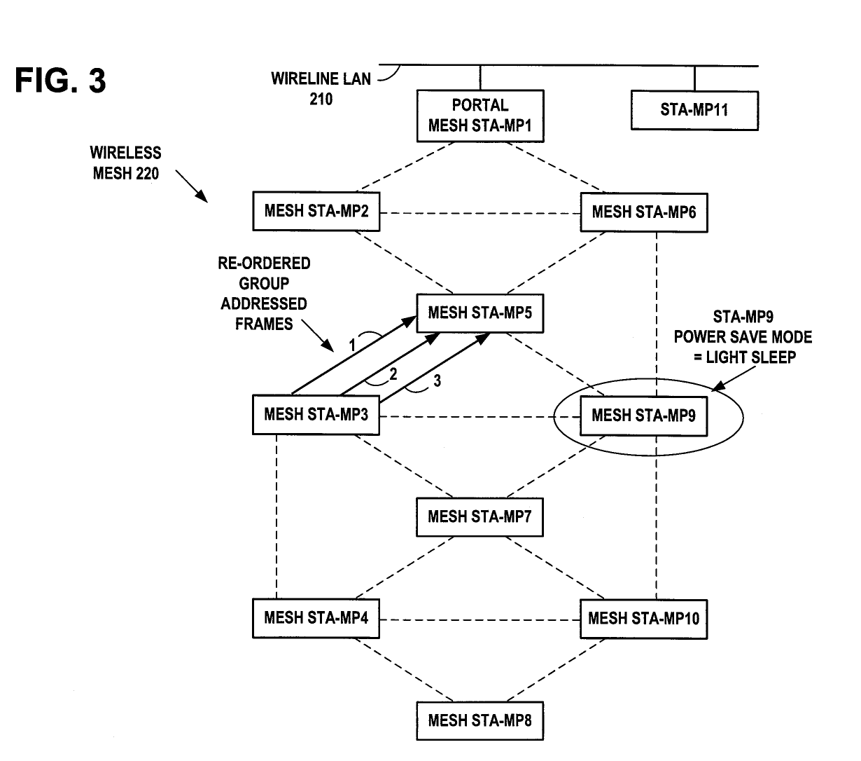

FIG. 3 illustrates an example embodiment of the IEEE 802.11s wireless mesh network 220 of FIG. 2, wherein a reordered arrangement for the three group addressed frames 1, 2, and 3 is transmitted from mesh STA-MP3 to mesh STA-MP5 in response to the determination that one of the wireless peer mesh devices MP9 in the network 220 is in the power save mode. The reordered arrangement transmits first the group addressed frames 3 and 1 having a source different from the portal wireless mesh device STA1, followed by transmitting the group addressed frames 2 that have the portal wireless mesh device STA1 as a source.

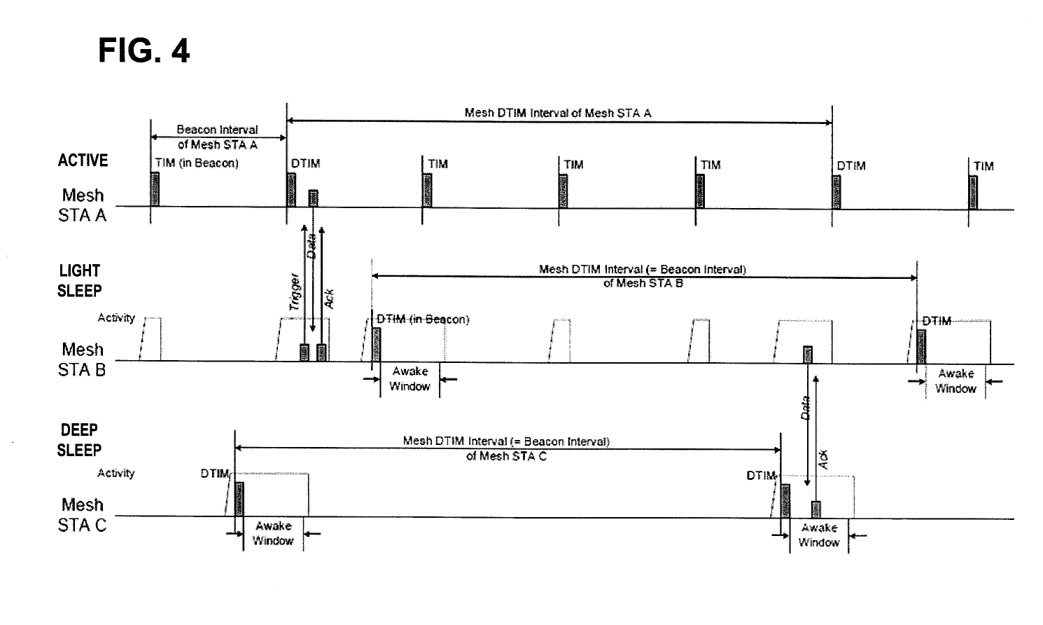

FIG. 4 is an example timing diagram comparing the beacon timing for an active wireless mesh device, such as MP3 or MP5 in the top row, with the beacon timing for a wireless mesh device in the light sleep power save mode such as MP9, in the middle row. For comparison, the figure shows the beacon timing for a wireless mesh device in the deep sleep power save mode in the bottom row.

A mesh STA operating in active mode is in the Awake state during which the device may receive peer trigger frames from a peer mesh STA in power save at all times when they do not have a peer service period ongoing.

A mesh STA operating in light sleep mode enters the Awake state prior to every target beacon transmission time (TBTT) that matches the Beacon timing of its own and peer mesh STA. The mesh STA remains in Awake state after its beacon transmission for the duration of the Awake Window and the duration of its group addressed frame transmissions or if the source address is a portal. The mesh STA may return to doze state after the Beacon reception from a peer mesh STA, to which it indicated to operate in light sleep mode, if the peer mesh STA did not indicate buffered individually addressed or group addressed frames. If a light sleep mode mesh STA enters the Awake state in order to listen to DTIM Beacon and group addressed transmissions from its peer mesh STA and the DTIM Beacon indicates the presence of buffered group addressed frames, the mesh STA remains Awake until the More Data field of the group addressed frames indicated the last group addressed frame or if the source address is a portal.

A mesh STA operating in deep sleep mode enters the Awake state prior to every target beacon transmission time (TBTT) of its own and remains in Awake state after the Beacon transmission for the duration of the Awake Window and the duration of its group addressed frame transmissions or if the source address is a portal. A mesh STA operating in deep sleep mode may not receive Beacon frames from its peer mesh STAs unless it maintains synchronization with peer mesh STAs.

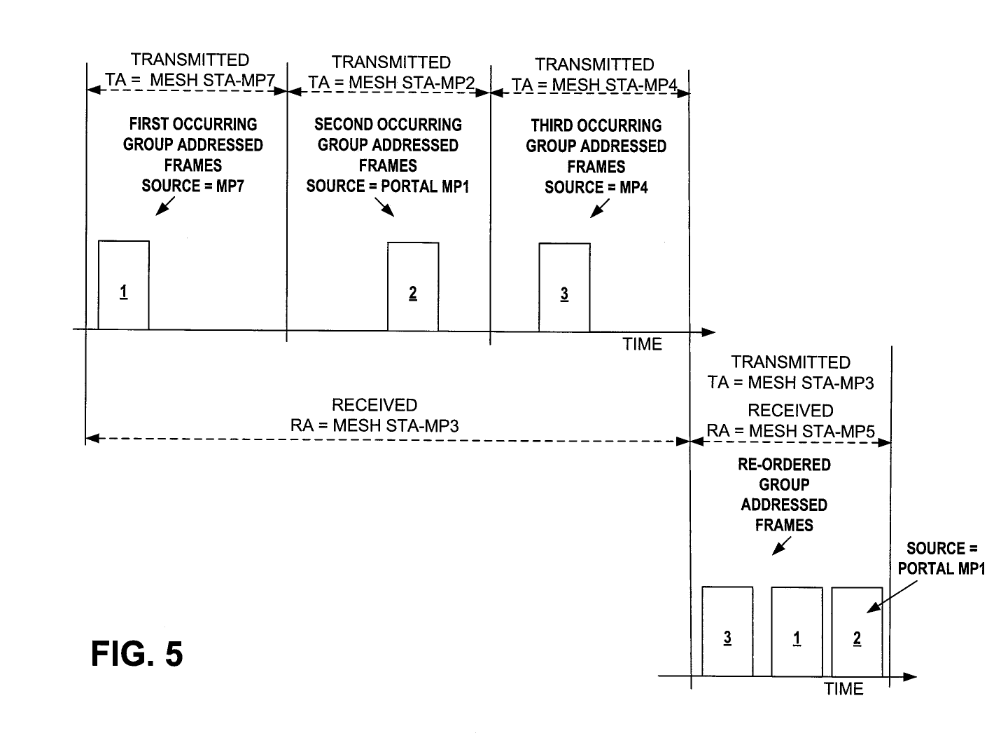

FIG. 5 is an example timing diagram showing the initial order of the group addressed frames 1, 2, and 3, as they are received at the wireless mesh device STA-MP3. The figure also shows the reordering the received group addressed frames as 3, 1, and 2, which is triggered by the processor 20 determining if there is at least one wireless peer mesh device MP9 in the network 220 that is in a power save mode. The figure shows the rearranged order of transmission of the group addressed frames 3 and 1, which are transmitted first because they have a source different from the portal wireless mesh device MP1 in the network 220, followed by group addressed frames 2 that have the designated portal mesh device STA-MP1 as a source. The rearranged order is received at the wireless mesh device STA-MP5.

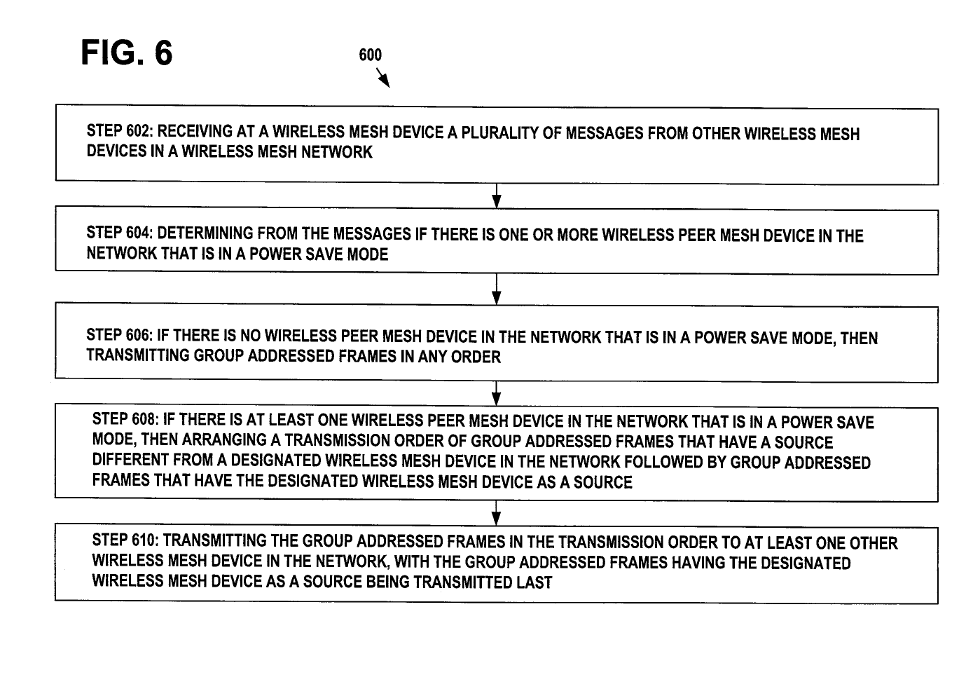

FIG. 6 illustrates an example embodiment of a flow diagram 600 for the process in an example wireless mesh device. An example embodiment of the invention receives at a wireless mesh device a plurality of messages from other wireless mesh devices in a wireless mesh network and determines from the messages if there is one or more wireless peer mesh device in the network that is in a power save mode. If there is no wireless peer mesh device in the network that is in a power save mode, then the example embodiment transmits group addressed frames in any order. If there is at least one wireless peer mesh device in the network that is in a power save mode, then the example embodiment arranges a transmission order of group addressed frames that have a source different from a designated wireless mesh device in the network followed by group addressed frames that have the designated wireless mesh device as a source. Then the example embodiment transmits the group addressed frames in the transmission order to at least one other wireless mesh device in the network, with the group addressed frames having the designated wireless mesh device as a source being transmitted last. The arrangement of the order of transmission enables other wireless mesh devices in the network to cease listening for further group addressed frames following receipt of the group addressed frames having the designated wireless mesh device as a source. In this manner power conservation and efficiency are improved in wireless mesh networks.

FIG. 6 is an example flow diagram of an example embodiment, depicting steps in the procedure 600 carried out by a wireless mesh device in executing-in-place program code stored in the memory of the wireless mesh device. The steps in the procedure of the flow diagram may be embodied as program logic stored in the memory of the wireless mesh device of FIG. 1 in the form of sequences of programmed instructions which, when executed in the microprocessor control logic of the wireless mesh device of FIG. 1, carry out the functions of an exemplary disclosed embodiment. The steps in the procedure 600 are as follows:

Step 602: receiving at a wireless mesh device a plurality of messages from other wireless mesh devices in a wireless mesh network.

Step 604: determining from the messages if there is one or more wireless peer mesh device in the network that is in a power save mode.

Step 606: if there is no wireless peer mesh device in the network that is in a power save mode, then transmitting group addressed frames in any order.

Step 608: if there is at least one wireless peer mesh device in the network that is in a power save mode, then arranging a transmission order of group addressed frames that have a source different from a designated wireless mesh device in the network followed by group addressed frames that have the designated wireless mesh device as a source.

Step 610: transmitting the group addressed frames in the transmission order to at least one other wireless mesh device in the network, with the group addressed frames having the designated wireless mesh device as a source being transmitted last.

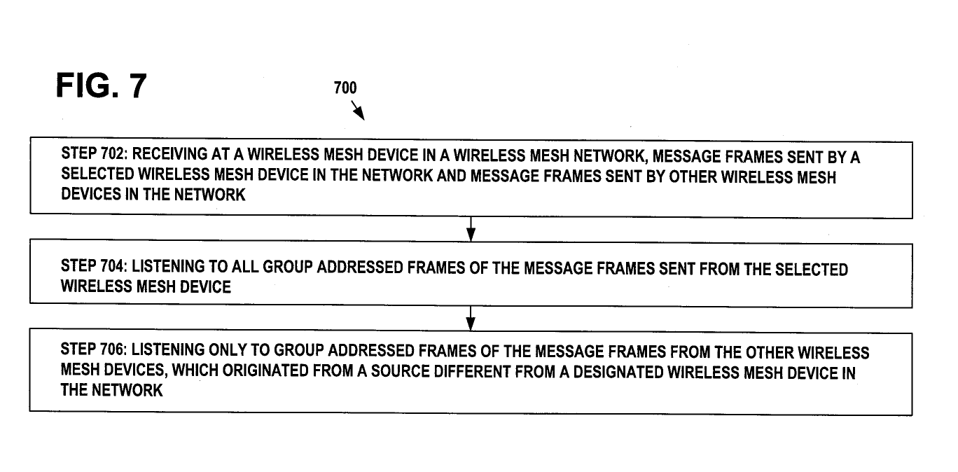

FIG. 7 illustrates an example embodiment of a flow diagram 700 for the process in a wireless mesh device in a wireless mesh network. An example embodiment of the invention receives at a wireless mesh device operating in power save mode in a wireless mesh network, message frames sent by a selected wireless mesh device in the network and message frames sent by other wireless mesh devices in the network. Then the example embodiment listens to all group addressed frames of the message frames sent from the selected wireless mesh device. Then the example embodiment listens only to group addressed frames of the message frames from the other wireless mesh devices, which originated from a source different from a designated wireless mesh device in the network.

FIG. 7 is an example flow diagram of an example embodiment, depicting steps in the procedure 700 carried out by a wireless mesh device in executing-in-place program code stored in the memory of the wireless mesh device. The steps in the procedure of the flow diagram may be embodied as program logic stored in the memory of the wireless mesh device of FIG. 1 in the form of sequences of programmed instructions which, when executed in the microprocessor control logic of the wireless mesh device of FIG. 1, carry out the functions of an exemplary disclosed embodiment. The steps in the procedure 700 are as follows:

Step 702: receiving at a wireless mesh device operating in power save mode in a wireless mesh network, message frames sent by a selected wireless mesh device in the network and message frames sent by other wireless mesh devices in the network.

Step 704: listening to all group addressed frames of the message frames sent from the selected wireless mesh device.

Step 706: listening only to group addressed frames of the message frames from the other wireless mesh devices, which originated from a source different from a designated wireless mesh device in the network.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than Wireless LAN networks.

What is claimed is:

1. A method, comprising:
receiving at a wireless mesh device a plurality of messages from other wireless mesh devices in a wireless mesh network;
determining from the messages if there is one or more wireless peer mesh device in the network that is in a power save mode;
if there is no wireless peer mesh device in the network that is in a power save mode, then transmitting group addressed frames in any order;
if there is at least one wireless peer mesh device in the network that is in a power save mode, then arranging a transmission order of group addressed frames that have a source different from a designated wireless mesh device in the network followed by group addressed frames that have the designated wireless mesh device as a source; and
transmitting the group addressed frames in the transmission order to at least one other wireless mesh device in the network, with the group addressed frames having the designated wireless mesh device as a source being transmitted last.

2. The method of claim 1, further comprising:
said designated wireless mesh device being a portal wireless mesh device in the network.

3. The method of claim 1, further comprising:
said received messages being beacons transmitted from other wireless mesh devices in the wireless mesh network.

4. The method of claim 1, further comprising:
said transmitting occurring after transmitting a Delivery Traffic Indication Message Beacon.

5. The method of claim 1, further comprising:
said arrangement of the order of transmission enabling other wireless mesh devices in the network to cease listening for further group addressed frames following receipt of the group addressed frames having the designated wireless mesh device as a source.

6. The method of claim 1, further comprising:
said group addressed frames being group addressed using at least one of a multicast or broadcast frame communication in a IEEE 802.11s wireless mesh network.

7. An apparatus, comprising:
a transceiver configured to receive a plurality of wireless messages from other wireless mesh devices in a wireless mesh network;
a processor configured to determine from the messages if there is one or more wireless peer mesh device in the network that is in a power save mode;
the processor further configured to determine if there is no wireless peer mesh device in the network that is in a power save mode, then causing the transceiver to transmit group addressed frames in any order;
the processor further configured to determine if there is at least one wireless peer mesh device in the network that is in a power save mode, then arrange a transmission order of group addressed frames that have a source different from a designated wireless mesh device in the network followed by group addressed frames that have the designated wireless mesh device as a source; and
the transceiver further configured to transmit the group addressed frames in the transmission order to at least one other wireless mesh device in the network, with the group addressed frames having the designated wireless mesh device as a source being transmitted last.

8. An apparatus according claim 7, further comprising:
the processor further configured to cause the transceiver to transmit the group addressed frames after transmission of a Delivery Traffic Indication Message Beacon.

9. An apparatus according to claim 7, further comprising:
said group addressed frames being group addressed using at least one of a multicast or broadcast frame communication in a IEEE 802.11s wireless mesh network.

10. A computer readable medium storing program instructions, which when executed by a computer processor, perform the steps comprising:
receiving at a wireless mesh device a plurality of messages from other wireless mesh devices in a wireless mesh network;
determining from the messages if there is one or more wireless peer mesh device in the network that is in a power save mode;
if there is no wireless peer mesh device in the network that is in a power save mode, then transmitting group addressed frames in any order;
if there is at least one wireless peer mesh device in the network that is in a power save mode, then arranging a transmission order of group addressed frames that have a source different from a designated wireless mesh device in the network followed by group addressed frames that have the designated wireless mesh device as a source; and
transmitting the group addressed frames in the transmission order to at least one other wireless mesh device in the network, with the group addressed frames having the designated wireless mesh device as a source being transmitted last.

11. A method, comprising:
receiving at a wireless mesh device operating in power save mode in a wireless mesh network, message frames sent by a selected wireless mesh device in the network and message frames sent by other wireless mesh devices in the network;
listening to all group addressed frames of the message frames sent from the selected wireless mesh device; and
listening only to group addressed frames of the message frames from the other wireless mesh devices, which originated from a source different from a designated wireless mesh device in the network.

12. The method of claim 11, further comprising:
said designated wireless mesh device being a portal wireless mesh device in the network.

13. The method of claim 11, further comprising:
ceasing to listen for further group addressed frames from the other wireless mesh devices following receipt of the group addressed frames having the designated wireless mesh device as a source.

14. The method of claim 11, further comprising:
said group addressed frames being group addressed using at least one of a multicast, or broadcast frame communication in a IEEE 802.11s wireless mesh network.

15. The method of claim 11, further comprising:
selecting a wireless mesh device in the network from which to receive the message frames.

16. An apparatus, comprising:
a transceiver configured to receive at a wireless mesh device operating in power save mode in a wireless mesh network, message frames sent by a selected wireless mesh device in the network and message frames sent by other wireless mesh devices in the network;
a processor configured to cause the apparatus to listen to all group addressed frames of the message frames sent from the selected wireless mesh device; and
the processor further configured to cause the apparatus to listen only to group addressed frames of the message frames from the other wireless mesh devices, which originated from a source different from a designated wireless mesh device in the network.

17. An apparatus according to claim 16, further comprising:
the processor further configured to cause the apparatus to cease listening for further group addressed frames from the other wireless mesh devices following receipt of the group addressed frames having the designated wireless mesh device as a source.

18. An apparatus according to claim 16, further comprising:
said group addressed frames being group addressed using at least one of a multicast, or broadcast frame communication in a IEEE 802.11s wireless mesh network.

19. A computer readable medium storing program instructions, which when executed by a computer processor, perform the steps comprising:
receiving at a wireless mesh device operating in power save mode in a wireless mesh network, message frames sent by a selected wireless mesh device in the network and message frames sent by other wireless mesh devices in the network;
listening to all group addressed frames of the message frames sent from the selected wireless mesh device; and
listening only to group addressed frames of the message frames from the other wireless mesh devices, which originated from a source different from a designated wireless mesh device in the network.
